(19) United States
(12) Patent Application Publication
(10) Pub. No.: US 2005/0207036 A1
(43) Pub. Date: Sep. 22, 2005

(54) Optical observation device

(75) Inventor: Jean-Loup Chretien, Morlaix (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Tietronix Optics, a corporation of France, Lannion (FR)

(21) Appl. No.: 11/121,246

(22) Filed: May 3, 2005

Related U.S. Application Data
(63) Continuation of application No. PCT/FR03/03289, filed on Nov. 4, 2003.

(30) Foreign Application Priority Data
Nov. 4, 2002 (FR) FR 02/13779

(51) Int. Cl. G01J 3/28

(52) U.S. Cl. 359/839

(57) ABSTRACT

An optical device including a dynamic filer of a source of very strong luminosity, wherein the filter includes a mirror with a zone of less reflection and a controller of the position of the mirror as a function of the position of the source of very strong luminosity in the image formed on the mirror.

### RELATED APPLICATION

This is a continuation of International Application No. PCT/FR2003/003289, with an international filing date of Nov. 4, 2003 (WO 2004/042437, published May 21, 2004), which is based on French Patent Application No. 02/13779, filed Nov. 4, 2002.

### FIELD OF THE INVENTION

This invention relates to optical equipment for the observation of scenes having a zone of very strong luminosity. It relates in particular, but in a non-limiting manner, to optical equipment for solar observation or for industrial imaging in environments using a laser beam.

### BACKGROUND

The observation of scenes having a zone of very strong luminosity produces a dazzling effect in the case of usage by a human operator or by a photosensitive sensor and even produces an irreversible degradation of the sensor.

A large number of optical systems (eye, cameras, sensors) undergo disturbances of performance and even irremediable alterations in situations of strong contrast of light in the presence of one or several high-intensity light sources. The sun is an example, as well as laser beams for military users. In such situations the natural reaction of every sensor is to close the diaphragm (iris of the human eye) to the maximum to protect itself. By way of compensation for this protection, the low light sources are no longer perceived and affect the performance of the sensor to the point of rendering it possibly unusable.

Various solutions for limiting dazzling effects have been proposed. A simple solution consists of using filters or a diaphragm that reduce the luminosity of the source of the dazzling. This solution is not very satisfying because it reduces the global level of luminosity and hides the low-luminosity parts observed.

WO 00/23833 A1 discloses a device and process for suppressing brilliant lights with holographic techniques. That device comprises a plurality of switched holographic elements (SHOE's), a plurality of detectors as well as a processing circuit connected to the SHOE's and the detectors. Each SHOE has a field of visualization. Each SHOE can correspond to a detector with a visual covering field covering practically the same points as the corresponding visualization field. When a light emitted by a brilliant source is incident relative to a detector, the detector sends an output signal to the processing circuit. The circuit actuates the corresponding SHOE, which diffracts a part of the incident light relative to the SHOE to remove the light from an individual capable of perceiving it. When there is no incident light relative to a detector the processing circuit stops the actuation of the corresponding SHOE, which permits the SHOE to transmit all the incident light without significant modification. These SHOE's can be manufactured from a liquid crystal material dispersed in a polymer.

The efficacy of that device is limited and disturbances of the low-luminosity zones remain too high for certain applications requiring a high fidelity of the image.

U.S. 2000000988855 discloses a dynamic filtration system consisting of bringing under control the opacity of a filtering element as a function of the luminous intensity detected by a sensor receiving part of the incident signal.

It would therefore be advantageous to provide a device that helps the incident beam containing the source(s) exceeding an adjustable threshold to be free of an excess quantity of light coming from these sources without altering the rest of the beam. The user could thus receive this modified beam and perceives the light coming from its initial source and not from a transformed image (e.g., an electronic image). Such a device would also be advantageous because numerous users or security services do not accept the use of electronic images instead of real images in all manned mobile systems.

### SUMMARY OF THE INVENTION

This invention relates to an optical device including a dynamic filtration means of a source of strong luminosity, wherein filtration means includes a mirror with a zone of less reflection and a means for controlling the position of the mirror as a function of position of the source of strong luminosity in the image formed on the mirror.

This invention also relates to an optical device including a dynamic filter of a source of strong luminosity, the dynamic filter including a mirror with a zone of less reflection and a controller of positions of the mirror as a function of position of the source of strong luminosity in the image formed on the mirror.

### BRIEF DESCRIPTION OF THE DRAWINGS

The invention will be better understood from a reading of the following description that makes reference to the attached drawings corresponding to non-limiting exemplary embodiments in which:

FIG. 1 is a schematic view of a device in accordance with aspects of the invention;

FIG. 2 represents the basic scheme of the invention; and

FIG. 3 is a schematic view of a device in accordance with other aspects of the invention.

### DETAILED DESCRIPTION

It will be appreciated that the following description is intended to refer to specific embodiments of the invention selected for illustration in the drawings and is not intended to define or limit the invention, other than in the appended claims.

The system of the invention includes input optics (objective), an active control filter across a detection/selection/regulation loop, an optional active complementary filtration stage where various information can also be superposed, and an output objective adapted for use.

The invention thus relates to an optical device comprising a dynamic filtration means of a source of very strong luminosity, wherein the filtration means comprises a mirror with a zone of less reflection and a means for bringing the position of this mirror under control as a function of the position of the source of very strong luminosity in the image formed on this mirror.

According to one aspect, the zone of less reflection is constituted of a hole. According to another aspect, the zone of less reflection is constituted of a diaphragm with variable section. According to another aspect, the zone of less reflection is constituted of a semi-reflecting zone.

The device preferably comprises an image analyzer that receives part of the incident beam and delivers a signal for controlling the mirror.

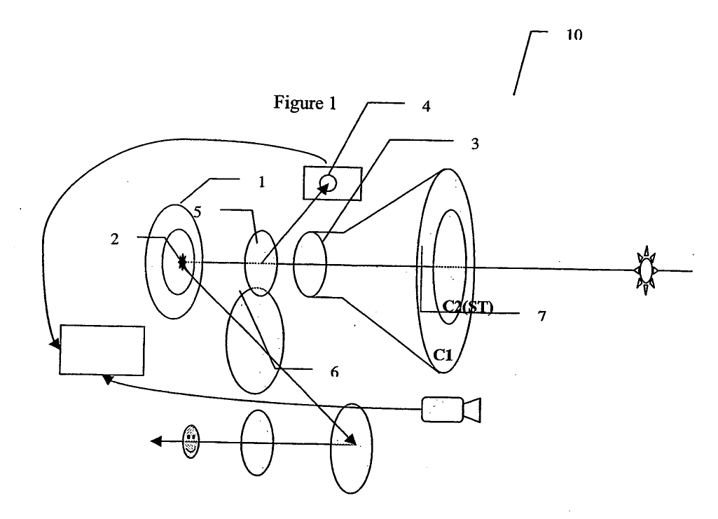

FIG. 1 is a view of an exemplary aspect of the invention. This example corresponds to a situation in which the source of very strong luminosity is the sun and constitutes the only dazzling source.

The device comprises a mirror 1 comprising a non-reflecting central zone 2. An image is formed on the mirror by objective 3 whose field and enlargement are determined in a known manner. The section of non-reflecting zone 2 is determined in such a manner as to correspond approximately to the section of the image of the dazzling source.

Beam divider 5 sends an image in conformity with the non-processed incident image back to sensor CCD 4. Sensor 4 delivers a signal to a calculator that determines the position of the center of the image of the dazzling source. Beam divider 5 is constituted, e.g., of a semi-transparent mirror with a very high transmission rate in such a manner that sensor 4 receives a light signal from the dazzling source compatible with its sensitivity.

This control signal can also be delivered by a camera 7 or other image device that is integral with the support of mirror 1 and that receives an image with an orientation that is constant in relation to optical axis 10 of the device.

Analysis of the signal supplied by the sensor permits the generation of the signals to control the position of mirror 1 relative to optical axis 10. The shift is assured along two axes X-Y perpendicular to optical axis 10 in such a manner that that the image of the source of dazzling is formed in low-reflection zone 2 on the optical axis when this zone is centered relative to mirror 1.

The processed image is then directed to eyepiece 6 for a direct observation or an observation by viewing equipment such as a camera or a photographic apparatus.

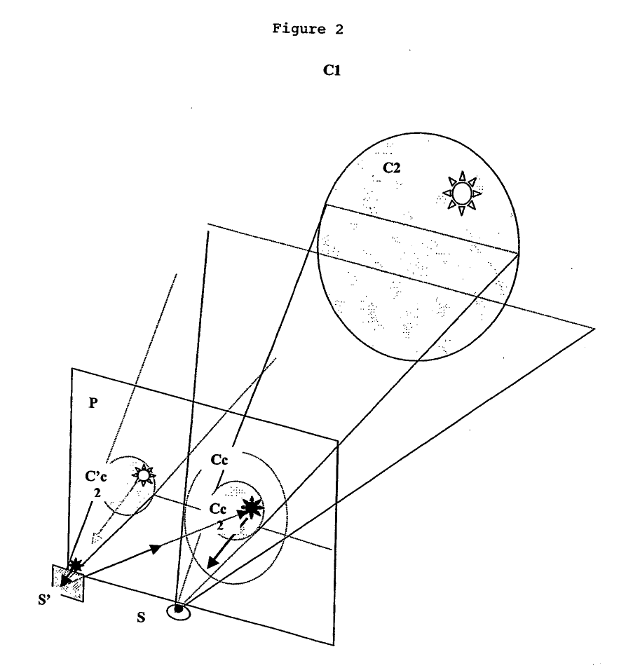

FIG. 2 shows the optical scheme of the described device. Observer S (the eye of the user, a camera, a photographic apparatus, a metrological instrument or the like) observes a scene to infinity with optical field C1. This optical field C1 has an active zone C2 in which the dazzling element, e.g., the sun, is situated.

Observer S and field C1 on the one hand and field C2 on the other hand define two cones.

Plane P perpendicular to the optical axis intersects the two cones. The intersection forms two surfaces Cc1 and Cc2 homothetic, respectively, with Cc1 and Cc2. These two surfaces are real surfaces and surface C2 is designated by “eclipse surface”. A second series of cones is formed between sensor S′ and fields Cc1 and Cc2. The intersection of plane P with these two cones is expressed, respectively, by surfaces Cc1 and Cc2. The latter surface is designated as “the dazzling surface”.

For most applications, surface Cc2 is suppressed and replaced by an equivalent surface coming from cone C1. For certain applications, the dazzling sources are multiple.

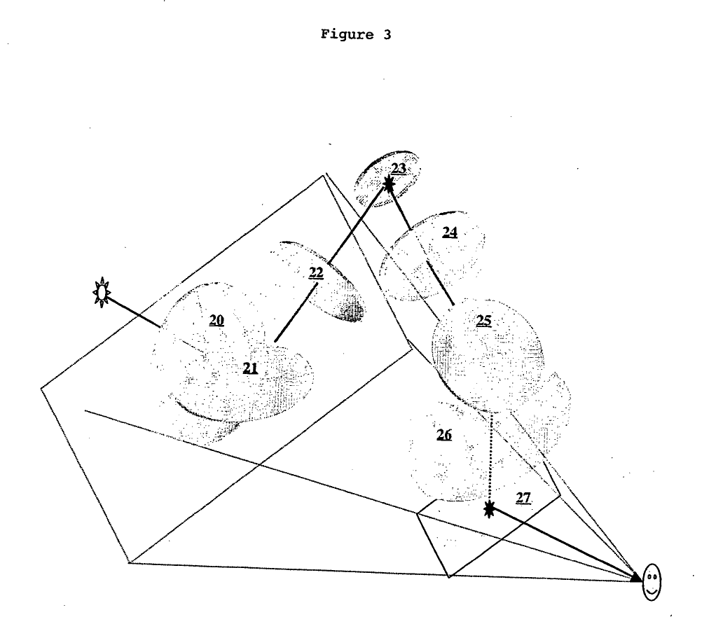

FIG. 3 shows another schematic view with respect to an optical compact block. It comprises an assemblage of lenses and a diaphragm forming an objective 20 of the “Edmund system” type.

By way of example, the objective has a focal length of 50 millimeters and comprises a doublet with a diameter of 25 mm, referenced by M32-323 in the Edmund Industrial Optics catalog (commercial name).

The incident beam is reflected by mirror 21 to reduce the longitudinal overall dimensions of the device. A group of lenses 22 ensures inversion of the image and works in setting 2f-2f.

Perforated mirror 23 is placed in the focal plane of the objective. Perforated mirror 23 is a plane mirror with a diameter of 10 mm and a conical piercing of 1.5 millimeters at its center. It is mounted on a motorized plate along two axes X-Y perpendicular to the optical axis. The conical piercing of the bottom of the mirror has the form of a cone with an angle at the top between about 40° and about 60° and a hole with an opening between about 1.2 and about 2.5 millimeters.

The movement of pierced mirror 23 is controlled by a calculator as a function of the signal delivered by a CCD (charge transfer camera) matrix. The output signal of this matrix is coded for each pixel on 2 bytes with the first one reserved for the blue and the second divided between the red and the green. The calculator realizes a threshold detection from a fixed threshold for each of the two bytes. If a pixel has a value greater than the threshold value for one of the two bytes, the calculator defines it as belonging to the zone of points Mi of the formation of the high-intensity light spot. The calculator then determines the barycenter G of this zone as well as the coordinates of the center of the zone. The threshold can also be determined in a dynamic manner.

The coordinates of the center of the zone are used to control the movement of the motors for positioning the perforated mirror. This movement can be realized pixel by pixel. In this instance the position of the perforated mirror is recalculated every time the position of the center of the spot is modified. The movement is calculated according to a formula to change the reference point that allows a passage from the reference system of the image to the reference system of the perforated mirror.

The movement can also be calculated inside a virtual grid corresponding to a division of the image in cells. In this instance, as long as the image of the center of the zone of high luminosity remains in the same cell the position of the mirror is unchanged.

When the position of the center of the spot changes cells, the mirror is moved. The size of the cells is selected in such a manner that the movement of the light source inside the cell does not dazzle the user. A size close to that of the opening of the hole of the perforated mirror constitutes a good compromise.

The device described in FIG. 3 also comprises field lens 24, reflecting mirror 25 and a group of lenses 26 forming an eyepiece. This eyepiece has the same focal length as objective 20.

In a general manner, the perforated mirror can be replaced by an equivalent means and in particular by a matrix mirror formed by a matrix of square micromirrors with sides of 16 micrometers. These micromirrors are mounted on actuators that ensure an orientation of ±10°.

The zone corresponding to the luminous spot is controlled in such a manner that the corresponding micromirrors reflect the light in a direction different than that corresponding to the optical axis. Such matrix mirrors permit the management of a plurality of sources with very strong luminosity.

Although this invention has been described in connection with specific forms thereof, it will be appreciated that a wide variety of equivalents may be substituted for the specified elements described herein without departing from the spirit and scope of this invention as described in the appended claims.

1. An optical device comprising a dynamic filtration means of a source of strong luminosity, wherein the filtration means comprises a mirror with a zone of less reflection and a means for controlling the position of the mirror as a function of position of the source of strong luminosity in the image formed on the mirror.

2. The optical device according to claim 1, wherein the zone of less reflection is a hole.

3. The optical device according to claim 2, wherein the hole is formed by a conical piercing in a bottom portion of the mirror.

4. The optical device according to claim 3, wherein the conical piercing is in the form of a cone with an angle at a top portion thereof between about 40° and about 60°.

5. The optical device according to claim 3, wherein the hole has an opening between about 1.2 and about 2.5 millimeters.

6. The optical device according to claim 2, wherein the zone of less reflection comprises a diaphragm with a variable section.

7. The optical device according to claim 1, wherein the mirror comprises a matrix of orientable micromirrors controlled to form a zone in which reflection is made in a direction different from a direction of reflection of a main beam.

8. The optical device according to claim 1, wherein the zone of less reflection comprises a semi-reflecting zone.

9. The optical device according to claim 1, further comprising an image analyzer that receives part of an incident beam and delivers a signal for controlling the mirror.

10. An optical device comprising a dynamic filter of a source of strong luminosity, the dynamic filter comprising a mirror with a zone of less reflection and a controller of positions of the mirror as a function of position of the source of strong luminosity in the image formed on the mirror.

11. The optical device according to claim 10, wherein the zone of less reflection is a hole.

12. The optical device according to claim 10, wherein the hole is formed by a conical piercing in a bottom portion of the mirror.

13. The optical device according to claim 10, wherein the conical piercing is in the form of a cone with an angle at a top portion thereof between about 40° and about 60°.

14. The optical device according to claim 10, wherein the hole has an opening between about 1.2 and about 2.5 millimeters.

15. The optical device according to claim 10, wherein the zone of less reflection comprises a diaphragm with a variable section.

16. The optical device according to claim 10, wherein the mirror comprises a matrix of orientable micromirrors controlled to form a zone in which reflection is made in a direction different from a direction of reflection of a main beam.

17. The optical device according to claim 10, wherein the zone of less reflection comprises a semi-reflecting zone.

18. The optical device according to claim 10, further comprising an image analyzer that receives part of an incident beam and delivers a signal for controlling the mirror.
